(19) United States
(12) Patent Application Publication
(10) Pub. No.: US 2015/0142993 A1
(43) Pub. Date: May 21, 2015

(54) CONNECTION COMPATIBILTY METHOD AND DEVICE

(71) Applicant: DENSO CORPORATION, Kariya-city, Aichi-pref. (JP)

(72) Inventors: David Blanc, Alcester (GB); Kurt Dusterhoff, Evesham (GB)

(21) Appl. No.: 14/406,428

(22) PCT Filed: Jun. 3, 2013
(86) PCT No.: PCT/JP2013/003484

§ 371 Date: Dec. 8, 2014

(30) Foreign Application Priority Data
Jun. 11, 2012 (GB) 1210246.3

(51) Int. Cl. G06F 13/40; G06F 13/10

(52) U.S. Cl. CPC G06F 13/4068; G06F 13/10
USPC 710/16

(57) ABSTRACT

A connection compatibility method is disclosed, which comprises: connecting a mobile device to a first in-vehicle connectivity port; receiving at an compatibility check unit, via the first connectivity port, identification information for the mobile device; determining, based on the identification information, whether the first connectivity port meets a connection requirement for the mobile device; and outputting if it is determined that the first connectivity port does not meet the connection requirement, a notification that the mobile device has been connected to a non-compliant connectivity port.

### CROSS REFERENCE

This application is based on GB Patent Application No. 1210246.3 filed on Jun. 11, 2012, the disclosure of which is incorporated herein by reference.

### FIELD

The present disclosure relates generally but not exclusively to a connection compatibility method and device.

### BACKGROUND

It is becoming more common for vehicles to be provided with connectivity ports, such USB, FireWire or audio Jack ports for connecting devices to an in-vehicle device. In some examples, such ports may be used to charge a mobile device, to transfer data to and/or from the mobile device and in-vehicle device, for example to send audio data to be played in the vehicle.

For example JP-2006-518507A discloses an arrangement where devices can be connected via USB to share content items. However, USB ports can have different characteristics such as different power supply characteristics and even USB ports with the same shape and appearance can provide different power supplies. Also, some mobile devices require different power supply settings for them to charge. Therefore, a mobile device can be connected to a suitably shaped port which however does not provide the adequate power for this mobile device to charge or operate as required. Unless the user checks the generally small icons on the mobile device, the user will not notice that the device is not charging and/or not operating normally because the USB port is not adapted for this specific mobile device.

### CITATION LIST

### Patent Literature

[PTL 1] JP-2006-518507A

### SUMMARY

In view of the foregoing, it is an object of the present disclosure to provide a connection compatibility method and device.

The present approach has been created in view of drawbacks of known systems. According to one aspect of the present disclosure, there is provided an arrangement for connecting a mobile device to an in-vehicle connectivity port while, for example, the user can be informed whether the connectivity port is compatible with the mobile device in a manner that enables the maintenance of the safety of the driver and passengers.

According to a second aspect of the disclosure, there is provided a method comprising connecting a mobile device to a first of a plurality of in-vehicle connectivity ports; receiving at a compatibility check unit, via the first connectivity port, identification information for the mobile device; determining, based on the identification information, whether the first connectivity port meets a connection requirement for the mobile device; and outputting, if it is determined that the first connectivity port does not meet the connection requirement, a notification that the mobile device has been connected to a non-compliant connectivity port. Such a method can not only check whether the mobile device has been plugged to a suitable connectivity port, but is can also do so while improving the security of the user by outputting a notification from the vehicle such that the user does not have, for example, to check a small icon on the mobile device.

The connectivity may be a USB, FireWire, HDMI, MHL, or audio Jack connectivity. For example, the connectivity ports may include one of USB type-A, USB type-B, USB mini-A, USB mini-B, USB micro-A and USB micro-B ports for USB connectivity. USB, FireWire, HDMI, MHL and audio Jack connectivity are now becoming more widely available on mobile devices and on in-vehicle devices.

The connection requirement may include at least one of a power supply characteristic, a connection capability and a throughput, any or all of which may be relevant, for example, to the charging of a mobile device and/or to the device being able to communicate as expected via the connection.

Outputting a notification may include at least one of playing sound; playing a voice message; displaying a message; outputting a visual signal. Such notifications can provide ways to safely inform a user that the mobile device has not been connected to an appropriate port.

Outputting a notification may include outputting a notification that identifies at least a second port of the plurality of in-vehicle connectivity ports. For example the remaining available connectivity ports may be identified by means of an illumination associated with the port. Once example may be a coloured illumination such as may be provided using a coloured LED. In one example, the available nature of the at least a second port may be indicated using a green LED.

Also, if it is determined that the first connectivity port does not meet the connection requirement, it may be detected whether one or more ports of the plurality of in-vehicle connectivity ports meet the connection requirement. If one or more ports have been detected, outputting a notification may then include outputting a notification that identifies the one or more ports. The notification may identify at least a second of the plurality of in-vehicle connectivity ports. The notifications may comprise an illumination associated with each port. For example, if it is determined that the first port is not suitable and that a second port is suitable for plugging the mobile device, a first colour illumination (such as might be provided using a red or orange LED or light) can be switched on for the first connectivity port and a second colour illumination (such as might be provided by a green LED or light) can be switched on for the second connectivity port so that the user can know which is (are) the most suitable connectivity port(s) for connecting the device, if any.

According to a third aspect of the disclosure, there is provided an in-vehicle device comprising a plurality of connectivity ports; and a compatibility check unit connected to the plurality of the connectivity ports. The compatibility check unit is operable to determine, upon receipt of identification information for a mobile device via the connectivity port, whether the in-vehicle connectivity port meets a connection requirement for the mobile device based on the identification information; and output, if it is determined that the connectivity port does not meet the connectivity connection requirement, a notification that the mobile device has been connected to a non-compliant connectivity port.

In the present disclosure, mobile device may refer to any mobile and/or portable device, for example a mobile phone (including a smartphone), a satellite navigation (sat nav) device, a tablet, a netbook, an audio player, a video player or a portable computer. Also, the term <vehicle> may refer to any transport, for example any form of car, lorry or motorcycle. Other clarifications as to the meaning of certain terms used herein can be found throughout the present disclosure.

### BRIEF DESCRIPTION OF DRAWINGS

Example embodiments will now be described by way of example only, with reference to the following drawings, which merely illustrate example arrangements in accordance with the presently disclosure and cannot be considered as limiting the scope of the present disclosure. In the drawings:

FIG. 1 is a schematic illustration of a mobile device and an in-vehicle device;

FIG. 2 is a flowchart illustrating a method for displaying a USB incompatibility warning;

FIG. 3 is a flowchart illustrating a further method for displaying a USB incompatibility warning;

FIG. 4A is an illustration of a first possible notification output;

FIG. 4B is an illustration of a second possible notification output; and

FIG. 4C is an illustration of a third possible notification output.

### DESCRIPTION OF EMBODIMENTS

While the disclosure is described herein by way of example for several embodiments and illustrative drawings, those skilled in the art will recognize that the disclosure is not limited to the embodiments or drawings described. It should be understood, that the drawings and detailed description thereto are not intended to limit the disclosure to the particular form, but on the contrary, the intention is to cover all modifications, equivalents and alternatives falling within the spirit and scope of the present disclosure. The headings used herein are for organizational purposes only and are not meant to be used to limit the scope of the description. As used throughout this application, the word <may> is used in a permissive sense (i.e. meaning <might>) rather than the mandatory sense (i.e., meaning <must>). Similarly, the words <include>, <including>, and <includes> mean including, but not limited to.

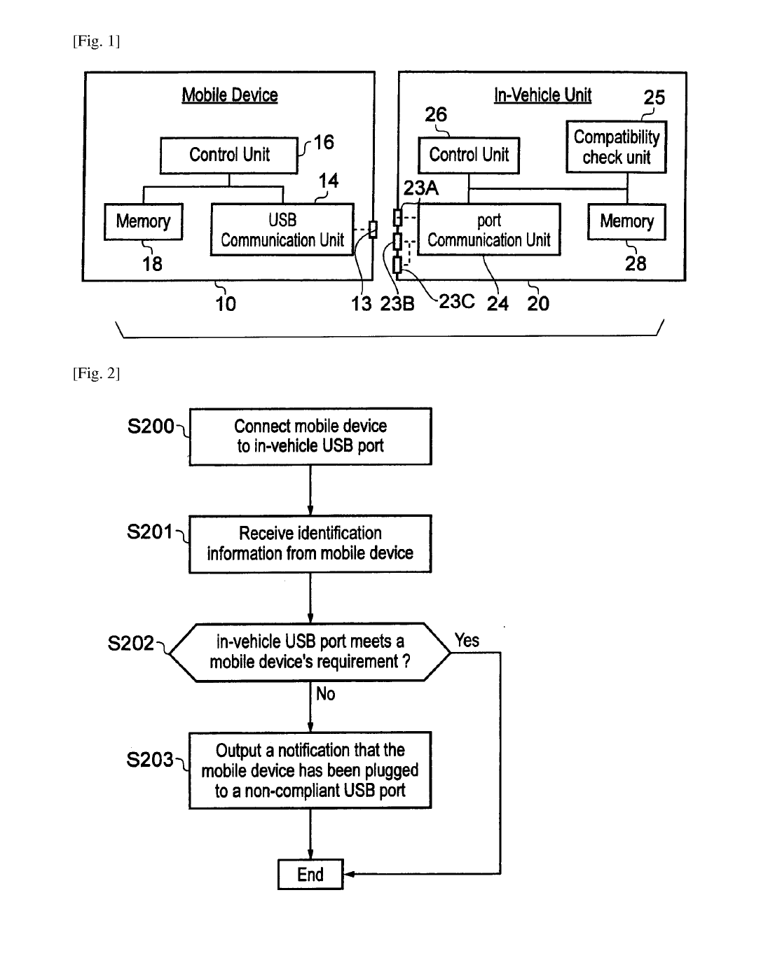

FIG. 1 is schematic illustration of a mobile device 10 and an in-vehicle device 20 which may be used in accordance with the present disclosure. The mobile device 10 is connectable to an in-vehicle device 20 and may include the following elements: a communication unit 14 connected to at least one connectivity port 13, a control unit 16 for controlling processes running on the mobile device 10, and a memory unit 18. On the other hand, the in-vehicle device 20 may include a port communication unit 24 having a plurality of connectivity ports, for example three in-vehicle ports 23A, 23B and 23C, a control unit 26 for controlling processes running on the in-vehicle device 20, a compatibility check unit 25 and a memory unit 28.

In the illustration of FIG. 1, three connectivity ports have been represented but the in-vehicle device could include two, four or more connectivity ports. Also, the ports may be provided in any arrangements. For example, one connection on the port communication unit 24 may correspond to one external connectivity port, as illustrated with port 23A in FIG. 1. Alternatively, one connection on the port communication unit 24 may correspond to more than one external connectivity port, as illustrated for example in FIG. 1 where one connection on the port communication unit 24 corresponds to two connectivity ports 23B and 23C. This is known for example for USB ports on a computer where more than one USB port may be connected in a hub-like arrangement to one USB connection on the appropriate internal element, e.g. a motherboard. The connectivity ports may for example be any suitable connectivity port. For example, for USB connectivity, if the USB ports may include at least one of type-A, type-B, mini-A, mini-B, micro-A and micro-B ports. In another example, for FireWire connectivity, the FireWire ports may include at least one of 4-conductor alpha, 6-conductor alpha, any other alpha, 9-conductors beta, any other beta, and any 8P8C (Ethernet-type) ports. If the connectivity is an HDMI connectivity, the HDMI ports may include for example any of HDMI type A to type E ports. If the connectivity is a MHL connectivity, the port may for example be a micro-USB port or any other type of physical port. If the connectivity is an audio Jack connectivity, the audio Jack ports may include at least one of 2.5 mm, 3.5 mm, 6.35 mm, mono, stereo, speaker-only, and speaker-microphone ports.

Also, the compatibility check unit 25 has been represented as a separate element but, in some examples, it may be part of the control unit 26 or of any other suitable element.

FIG. 2 is a flowchart illustrating a method for outputting a notification that the mobile device 10 has been connected to a non-compliant connectivity port. In this example the connectivity port is a USB port but in other examples, the connectivity port may be any other suitable type of connectivity port, e.g. FireWire, audio Jack, etc. At step S200, the mobile device 10 is connected to one of the in-vehicle ports 23n. Then, at step A201, identification information for the mobile device is received at the in-vehicle device. For example, the identification information may include at least one of: a model number, a serial number, a manufacturer, and connectivity identification information. In some example, the identification information may also include connectivity (USB in the example of FIG. 2) capabilities and/or requirements information. For example, in the case of USB, the USB capabilities may include the type of drivers supported by the device, e.g. CDC-ACM, CDC-ECM, RTP, RNDIS, to enable for example the in-vehicle device 20 to check what is available on the mobile device to select a mode to connect, such as the mode identified as the optimum mode. Also, the model number, serial number and manufacturer may be in respect of the mobile device 10 or in respect of any element involved for the connectivity, such as a connectivity card, if any.

At step S202, it is determined whether the USB port 23n meets a connection requirement for the mobile device 10 based on the identification information. The connection requirement may include for example one or more of a power supply characteristic, a throughput, or any other appropriate connection requirement. In one example, the compatibility check unit 25 of the in-vehicle device 20 may determine that the mobile device requires at least a minimum current supply to charge (for example 200 mA or 500 mA) based on the serial number of the mobile device 10 and determines whether the USB port 23n to which the mobile device 10 is currently connected meets this requirement. Different methods may be used to determine a connection requirement for the mobile device 10 based on the identification information. For example, if the identification information includes a serial number, the in-vehicle device may retrieve a connection requirement from an element, for example a table, a database or any other organised form of data store. In one example, the element may be part of the in-vehicle device, e.g. a table stored in the memory unit 28. In another example, the element may be a remote element, for example, the in-vehicle device may include wireless (e.g. 3G, 4G, Wimax, etc.) communication means and may query a remote element for a connection requirement for the mobile device 10. In another example, the connection requirement may be based more directly on the identification information, for example on connectivity capabilities and/or requirements information. In this case, the identification information may for example include a minimum power supply or a minimum throughput for a feature to be available (e.g. charging of mobile phone, transmission of a stereo sound signal). For example some mobile devices may require specific charging requirements: in some examples a mobile device can charge faster than a rate specified by a relevant standard (e.g. can support a higher power delivery rate than defined in the connectivity standard to charge faster). For example, mobile devices made by a specific manufacturer may all be capable of supporting a higher power supply such that, based on an identification of the mobile device (e.g. via brand or model information), the in-vehicle device (also called an in-vehicle unit) 20 may be in a position to identify this higher power supply capability of the mobile device 10. In such examples, if the compatibility check unit 25 identifies that the current USB port can not supply the maximum power supply that the mobile device can support and thus output a notification accordingly. In an audio connectivity example, a connectivity requirement may be an analogue audio capability and the in-vehicle device 20 may output a notification if it is detected that the mobile device 10 has been connected to for example a digital audio port. Once the connection requirement has been identified, the connection requirement may be compared with the connectivity capabilities of the in-vehicle connectivity port used by the mobile device 10.

If it is determined at step S202 that the USB port 23n meets the connectivity requirement for the mobile device 10, the method ends. If however it is at step S202 that the USB port 23n does not meet the connectivity requirement for the mobile device 10, the methods moves to step S203. A notification is then output to inform the user that the mobile device 10 has been plugged to a non-compliant USB port. Outputting a notification may include one or more of playing sound; playing a voice message; displaying a message, for example on the display of the in-vehicle device or on a head-up display; and outputting a visual signal, for example using a light or indicator. Any audio notification may be output via for example the in-vehicle sound system or via any other suitable means. Some examples of notifications are discussed further below.

There has therefore now been described an arrangement which can check whether a mobile device 10 connected to an in-vehicle device 20 is connected via a connectivity port which matches a connection requirement for the mobile device 10. In particular, the described approach enables such checking in a manner safe for a user in a vehicle.

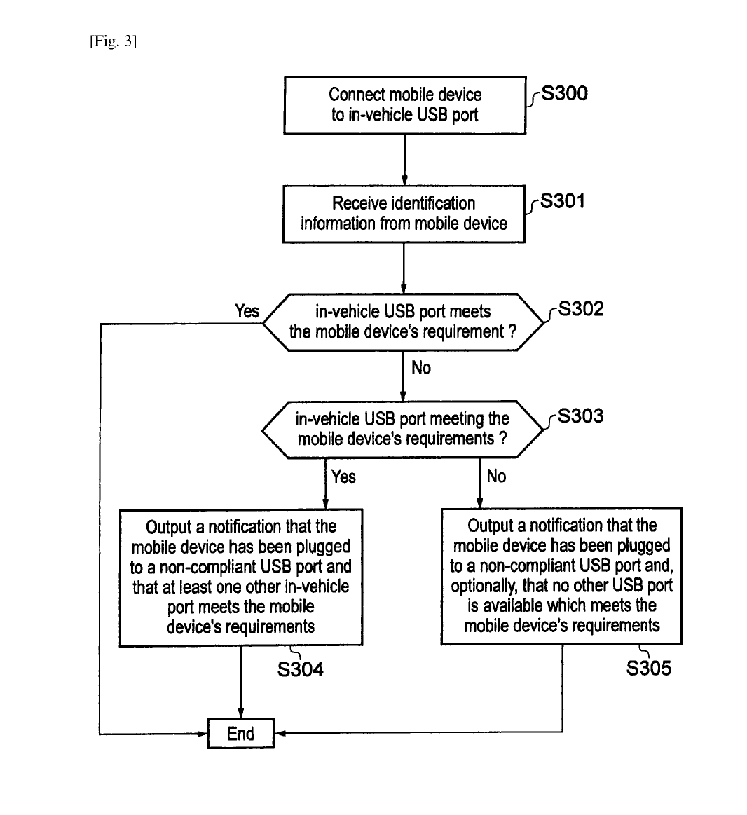

FIG. 3 is a flowchart illustrating a further method for checking whether a mobile device is connected to a compliant connectivity port and, in dependence upon the result of this check, conditionally outputting a notification that the mobile device 10 has been connected to a non-compliant connectivity port. In this example the connectivity port is also a USB port but in other examples, the connectivity port may also be any other suitable type of connectivity port, e.g. FireWire, audio Jack, etc. At step S300 the mobile device 10 is connected to one of a plurality of in-vehicle USB ports 23n. Then at step S301, identification information in respect of the mobile device is received for example at the compatibility check unit 25. The discussion of identification information above in respect of FIG. 2 applies equally to the present discussion of FIG. 3, and to any other suitable example, embodiment, or alternative under the present disclosure.

Then at step S302, it is determined for example by the compatibility check unit whether the in-vehicle USB port 23n meets a connection requirement of the mobile device 10. The step S302 may carried out in similar fashion to step S202 discussed above. If the USB port 23n meets the connection requirement of the mobile device 10, the method can then end.

If however, the USB port 23n does not meet the connection requirement of the mobile device 10, the method then moved on to step S303 where it is determined whether any in-vehicle USB port meets the connection requirement of the mobile device 10. For example, if the mobile device requires at least a minimum current supply to charge (for example 200 mA or 500 mA) and the port 23n to which the mobile device 10 is currently connected does not supply the required minimum current, it can be determined, for example by the compatibility check unit 25, whether any other corresponding USB port (e.g. same-shape USB plug) meets the connection requirement. Optionally, it can also be determined whether the compatible USB ports are available or currently used.

If no compatible USB port can be identified, the method moves on to step S305 where a notification is output, the notification being that the user that the mobile device has been plugged to a non-compliant USB port and, optionally, the notification may also be that no other USB port is available which meets the connection requirement.

If however at least one compliant USB port has been identified, the method carried on to step S304 when a notification is output, the notification being that the user that the mobile device has been plugged to a non-compliant USB port and that at least one other vehicle port meets the connection requirement of the mobile device 10. In some example, the notification may include an indication on a display of the in-vehicle device 20 such as arrows identifying the compatible USB ports and/or using lights (for example LED) to identify compatible USB ports and non-compatible USB ports.

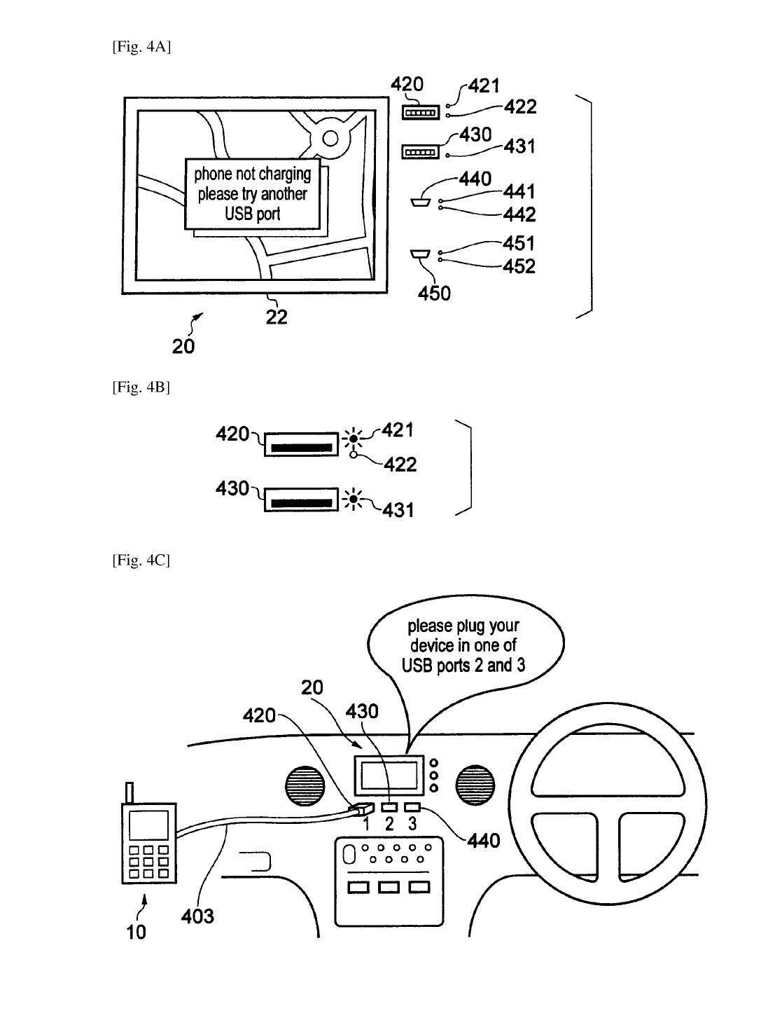

FIGS. 4A-4C are illustrations of possible notification outputs. In FIG. 4A, an in-vehicle device 20 includes an in-vehicle display 22 and four USB port, including in this example two type-A USB ports 420 and 430 and two mini-A USB ports 440 and 450. In this example, the USB ports are provided with lights 421, 422, 431, 441, 442, 451, and 452 which lights may be LED lights. In this example, a visual notification is provided on the in-vehicle display 22 which shows the message <phone is not charging—please try another USB port>. In some example, the notification additionally or alternatively includes a visual notification, for example using the lights.

In the example of FIG. 4B, two possible notification arrangements have been illustrated, which may be appropriate to use in one example when the in-vehicle device 20 does not include any display or, in another example, to supplement a visual display. In the first one, the USB port 420 is provided with two different lights 421, 422. The lights 421, 422 may for example be used to output different notifications. For example, in the example method of FIG. 2, at step S203 all USB available ports may be identify with light, e.g. to inform the user that he could try these USB ports because the current USB port does not meet the connection requirements. Any light signal may be used, for example the light being turned on or off, flashing the light, and/or using different colours for the light. As an illustration, the light for the non-compatible USB port may be flashing between red and green colours when it is detected that is it not compatible while the lights for the other USB ports may be turned green to identify the available USB ports. In the second possible arrangement, the USB port 430 is associated with one light 431 only and this light may be used when outputting the notification. For example, a non-compliant USB port may have a flashing red LED while any other compliant port may have the red LED turned on (not flashing), or may have its red LED kept or turned off.

Also, in a possible combination of the example method of FIG. 3 with the notification example of FIG. 4B, the lights may be used for the notification as to which USB port is now compatible with the connection requirement of the mobile device 10. For example, the lights can be used to output a notification differencing the USB port currently used and which is not compatible with the connection requirement, any USB port that is compatible with the connection requirements and, optionally, any USB port that is not compatible with the connection requirement.

In the example of FIG. 4C, the in-vehicle device 20 can output an audio notification. In one example, the in-vehicle device 20 may include an audio system and may be operable to cause the audio system to output an audio notification, for example to play a sound or a message. In another example, the in-vehicle device 20 may be operable to cause an audio system (e.g. a sound system of the vehicle) to output an audio notification such as a sound or a message. In the example of FIG. 4C, a mobile device 10 is connected to an in-vehicle device 20 having three USB ports 420, 430, and 440 (identified as 1; 2 and 3, respectively, in the vehicle) via a USB cable 403. The mobile device 10 is connected to USB port 420 (USB port 1). In this example, if it has been detected that the USB port 420 does not meet a connection requirement of the mobile device 10 but that USB ports 430 and 440 (USB ports 2 and 3) each meets the connection requirement, the in-vehicle device 20 outputs a audio notification, in this case a voice message. The voice message <plug your device in one of USB ports 2 and 3> notifies the user not only that the USB port 420 (port 1) currently used does not meet the connection requirement for the mobile device 10 but also that USB ports 430, 440 (ports 2 and 3) meet this requirement.

Other modifications and/or additions can be carried out to any of the previously discussed methods or arrangements as described below.

For example, the connectivity ports are not limited to USB ports (any type of USB ports) as illustrated in the example, or to the audio Jack and FireWire (sometimes referred to as IEEE 1394, i.Link or Lynx) alternatives discussed above. Any other appropriate type of connectivity may be used and, for each type of connectivity, any type of port may be used.

Additionally, the connection requirement may include at least an electrical supply requirement, a throughput requirement, and/or a connection capability requirement. An electrical supply requirement may include at least a minimum and/or maximum value, wherein the value may be an amperage, voltage, power, impedance, or any other appropriate value. For example to check whether the power supply characteristics are sufficient for one or more functions (e.g. charging) to operate or to check that it will not damage the mobile device if one power supply characteristic is excessively high for this mobile device. A throughput requirement may include a minimum, maximum and/or average throughput value for example to check whether the connection is likely to be sufficient for the mobile device to operate. If for example the mobile has to send or receive data (e.g. music, display information, video, satellite navigation information, etc.) over the connectivity link in order for a function to operate in a satisfactory manner, it can be appropriate to check whether any of these requirements are met. A connection capability requirement may include for example a mono/stereo capability for an audio connectivity; a microphone capability; a video and sound, video only, or sound only capability for a video connectivity; etc. If for example a mobile device is used to show a video on a screen of the in-vehicle device and/or to transmit satellite navigation video and sound to an in-vehicle device and/or if it is used in combination with an in-vehicle device for a voice command system, it may be appropriate to check the video and/or sound and/or microphone capabilities provided by the connectivity port.

Outputting a notification includes outputting a notification in any appropriate manner. For example it may include playing sound, e.g. a bleeping sound; playing a voice message, e.g. to inform a user of incompatibility with the connection requirement of the mobile device; displaying a message, for example on a screen of the in-vehicle device, on a head-up display or any other suitable display; and outputting a visual signal, for example lighting a symbol on the dashboard, displaying an icon an in-vehicle display (e.g. a head-up display), turning on and/or off one or more lights of any colour, flashing one or more lights of any colour at any frequency, etc.

Additionally, the selection of the type of notification output may depend on one or more parameters, for example fixed (e.g. pre-configured), configurable (e.g. by the user and/or another party), and/or dynamic parameters. For example, it may decided that, if the speed of the vehicle is higher than a threshold, then a message notification will be output on a head-up display only, but if the vehicle speed is less than the threshold, then a message notification will be output on an in-vehicle display and on a head-up display, so that the message notification can be appropriately output depending on the parameters. In some examples, a notification may or may not be output depending on a parameter, e.g. if the vehicle speed is very high, outputting any notification may be considered as unsafe and no notification will be output, or only a discrete notification will be output (e.g. turning on or off a LED next to the connectivity port). In other examples, one or more notifications may be delayed until a certain condition is met. For example, an LED notification may be output as soon as the incompatibility has been detected, but an audio message (e.g. voice message or other sound) may be delayed until the vehicle speed has decrease below a certain limit (e.g. the vehicle has stopped) or until the vehicle has exited a particular zone (e.g. a high-speed or -risk zone). In this illustrative example, the driver is not disturbed by the audio message while driving for example at high speed. And when the vehicle speed has been decreased to a lower value, the audio message may be played to the user.

The parameters discussed in the above-paragraph, and the connection requirement may be configurable. For example, a party may be provided with the option to overwrite one or more of the parameters and/or connection requirement. In one example, when a notification is output to the user using a display of an in-vehicle device, the user may be prompted to overwrite the connection requirement. For example, in an event where a mobile device has been connected to an in-vehicle connectivity port and that it is has been detected that this port does not provide enough amperage for the mobile device to charge, and if the user notices that the phone is actually charging, the user may overwrite the connection requirement for this mobile device. In some examples, this may be done temporarily (e.g. for the duration of the connection) or permanently (e.g. fixed to this value unless it is overwritten at a later point in time). If for example a table or database of the in-vehicle device is used to determine the connection requirement, the table may be updated accordingly. Optionally, the overwriting information may be sent to a remote element. This may be appropriate for example to keep track of any error in a table or database for identifying a connection requirement based on identification information. For example, it may be noted that a table used by in-vehicle device contains inaccurate information based on a statistical analysis of overwriting information and that it would be appropriate to update the table (e.g. remote update via a wireless connection or next time the in-vehicle device is connected to a garage diagnostic and/or repair apparatus). Also, in some examples overwriting instructions may be sent from a remote element to the in-vehicle device. For example if it has been detected that the tables in in-vehicle devices and/or parameters are inaccurate, overwriting instructions may be sent to the in-vehicle device to overwrite inaccurate information with information considered as more accurate.

The identification information sent via the connectivity port may be sent automatically (for example as part of a discovery messages exchange) or on request. For example the in-vehicle device may be operable to detect that a device is connected to the connectivity port and send an identification information request to the device.

According to the present disclosure, a connection compatibility method and an in-vehicle device can be provided in various forms, examples of which will be described.

According to a first example, a connection compatibility method comprises: connecting a mobile device to a first connectivity port, which is a first port of a plurality of in-vehicle connectivity ports; receiving at a compatibility check unit, via the first connectivity port, identification information for the mobile device; determining, based on the identification information, whether the first connectivity port meets a connection requirement for the mobile device; and outputting if it is determined that the first connectivity port does not meet the connection requirement, a notification that the mobile device has been connected to a non-compliant connectivity port, wherein the outputting a notification includes outputting a notification that identifies at least a second port of the plurality of in-vehicle connectivity ports.

In the first example, the first connectivity port may be a USB, FireWire, HDMI, MHL, or audio Jack connectivity port. The determining may comprise identifying the connection requirement based on the identification information, and comparing the identified connection requirement with the connectivity capabilities of the first connectivity port. The connection requirement may include at least one of a power supply characteristic, a connection capability and a throughput. The outputting a notification may include at least one of playing sound; playing a voice message; displaying a message; and outputting a visual signal. The connection compatibility method nay further comprise: if it is determined that the first connectivity port does not meet the connection requirement, detecting whether one or more ports of the plurality of in-vehicle connectivity ports meet the connection requirement; and if one or more ports have been detected, outputting a notification includes outputting a notification that identifies the one or more ports.

According to a second example, a connection compatibility method comprises: connecting a mobile device to a first connectivity port, which is a first port of a plurality of in-vehicle connectivity ports; receiving at a compatibility check unit, via the first connectivity port, identification information for the mobile device; determining, based on the identification information, whether the first connectivity port meets a connection requirement for the mobile device; and outputting if it is determined that the first connectivity port does not meet the connection requirement, a notification that the mobile device has been connected to a non-compliant connectivity port; if it is determined that the first connectivity port does not meet the connection requirement, detecting whether one or more ports of the plurality of in-vehicle connectivity ports meet the connection requirement; and if one or more ports have been detected, outputting a notification includes outputting a notification that identifies the one or more ports.

In the second example, the first connectivity port may be a USB, FireWire, HDMI, MHL, or audio Jack connectivity port. The determining may comprise identifying the connection requirement based on the identification information, and comparing the identified connection requirement with the connectivity capabilities of the first connectivity port. The connection requirement may include at least one of a power supply characteristic, a connection capability and a throughput. The outputting a notification may include at least one of playing sound; playing a voice message; displaying a message; and outputting a visual signal. The outputting a notification may include outputting a notification that identifies at least a second port of the plurality of in-vehicle connectivity ports.

According to a third example, an in-vehicle device comprises: a plurality of connectivity ports; and a compatibility check unit connected to the plurality of the connectivity ports. The compatibility check unit is operable to: determine, upon receipt of identification information for a mobile device via a first connectivity port being a first port of the plurality of the connectivity ports, whether the first in-vehicle connectivity port meets a connection requirement for the mobile device based on the identification information; and output, if it is determined that the first connectivity port does not meet the connectivity connection requirement, a notification that the mobile device has been connected to a non-compliant connectivity port. The compatibility check unit being operable to output a notification includes the compatibility check unit being operable to output a notification which identifies at least a second connectivity port, which is a second port of the plurality of in-vehicle connectivity ports.

In the third example, the first connectivity port may be a USB, FireWire, or audio Jack connectivity. The connection requirement may include at least one of a power supply characteristic, a connection capability and a throughput. The compatibility check unit being operable to output a notification may include at least one of the compatibility check unit being operable to play sound; the compatibility check unit being operable to play a voice message; the compatibility check unit being operable to display a message; and the compatibility check unit being operable to output a visual signal. The compatibility check unit may be operable to detect, if it is determined that the first connectivity port does not meet the connection requirement, whether one or more ports of the plurality of in-vehicle connectivity ports meet the connection requirement. The compatibility check unit being operable to output a notification may include the compatibility check unit being operable to output, if one or more ports have been detected, a notification that identifies the one or more ports.

In a fourth example, an in-vehicle device comprises: a plurality of connectivity ports; and a compatibility check unit connected to the plurality of the connectivity ports. The compatibility check unit is operable to: determine, upon receipt of identification information for a mobile device via a first connectivity port being a first port of the plurality of connectivity ports, whether the first in-vehicle connectivity port meets a connection requirement for the mobile device based on the identification information; and output, if it is determined that the first connectivity port does not meet the connectivity connection requirement, a notification that the mobile device has been connected to a non-compliant connectivity port. The compatibility check unit is operable to detect, if it is determined that the first connectivity port does not meet the connection requirement, whether one or more ports of the plurality of in-vehicle connectivity ports meet the connection requirement; wherein the compatibility check unit being operable to output a notification includes the compatibility check unit being operable to output, if one or more ports have been detected, a notification that identifies the one or more ports.

In the fourth example, the connectivity may be a USB, FireWire, or audio Jack connectivity. The connection requirement may include at least one of a power supply characteristic, a connection capability and a throughput. The compatibility check unit being operable to output a notification may include at least one of the compatibility check unit being operable to play sound; the compatibility check unit being operable to play a voice message; the compatibility check unit being operable to display a message; and the compatibility check unit being operable to output a visual signal. The compatibility check unit being operable to output a notification may include the compatibility check unit being operable to output a notification which identifies at least a second of the plurality of in-vehicle connectivity ports.

1. A method comprising:
connecting a mobile device to a first connectivity port, which is a first port of a plurality of in-vehicle connectivity ports;
receiving at a compatibility check unit, via the first connectivity port, identification information for the mobile device;
determining, based on the identification information, whether the first connectivity port meets a connection requirement for the mobile device; and
outputting if it is determined that the first connectivity port does not meet the connection requirement, a notification that the mobile device has been connected to a non-compliant connectivity port,
wherein outputting a notification includes outputting a notification that identifies at least a second port of the plurality of in-vehicle connectivity ports.

2. The method of claim 1, wherein the first connectivity port is a USB, FireWire, HDMI, MHL, or audio Jack connectivity port.

3. The method of claim 1, wherein the determining comprises identifying the connection requirement based on the identification information, and comparing the identified connection requirement with the connectivity capabilities of the first connectivity port.

4. The method of claim 1, wherein the connection requirement includes at least one of a power supply characteristic, a connection capability and a throughput.

5. The method of claim 1, wherein outputting a notification includes at least one of playing sound; playing a voice message; displaying a message; and outputting a visual signal.

6. The method of claim 1, further comprising:
if it is determined that the first connectivity port does not meet the connection requirement, detecting whether one or more ports of the plurality of in-vehicle connectivity ports meet the connection requirement; and
if one or more ports have been detected, outputting a notification includes outputting a notification that identifies the one or more ports.

7. A method comprising:
connecting a mobile device to a first connectivity port, which is a first port of a plurality of in-vehicle connectivity ports;
receiving at a compatibility check unit, via the first connectivity port, identification information for the mobile device;
determining, based on the identification information, whether the first connectivity port meets a connection requirement for the mobile device; and
outputting if it is determined that the first connectivity port does not meet the connection requirement, a notification that the mobile device has been connected to a non-compliant connectivity port,
wherein:
if it is determined that the first connectivity port does not meet the connection requirement, detecting whether one or more ports of the plurality of in-vehicle connectivity ports meet the connection requirement; and
if one or more ports have been detected, outputting a notification includes outputting a notification that identifies the one or more ports.

8. The method of claim 7, wherein the first connectivity port is a USB, FireWire, HDMI, MHL, or audio Jack connectivity port.

9. The method of claim 7, wherein the determining comprises identifying the connection requirement based on the identification information, and comparing the identified connection requirement with the connectivity capabilities of the first connectivity port.

10. The method of claim 7, wherein the connection requirement includes at least one of a power supply characteristic, a connection capability and a throughput.

11. The method of claim 7, wherein outputting a notification includes at least one of playing sound; playing a voice message; displaying a message; and outputting a visual signal.

12. The method of claim 7, wherein outputting a notification includes outputting a notification that identifies at least a second port of the plurality of in-vehicle connectivity ports.

13. An in-vehicle device comprising:
a plurality of connectivity ports; and
a compatibility check unit connected to the plurality of the connectivity ports,
wherein the compatibility check unit is operable to:
determine, upon receipt of identification information for a mobile device via a first connectivity port being a first port of the plurality of the connectivity ports, whether the first in-vehicle connectivity port meets a connection requirement for the mobile device based on the identification information; and
output, if it is determined that the first connectivity port does not meet the connectivity connection requirement, a notification that the mobile device has been connected to a non-compliant connectivity port;
wherein the compatibility check unit being operable to output a notification includes the compatibility check unit being operable to output a notification which identifies at least a second connectivity port, which is a second port of the plurality of in-vehicle connectivity ports.

14. The in-vehicle device of claim 13, wherein the first connectivity port is a USB, FireWire, or audio Jack connectivity.

15. The in-vehicle device of claim 13, wherein the connection requirement includes at least one of a power supply characteristic, a connection capability and a throughput.

16. The in-vehicle device of claim 13, wherein the compatibility check unit being operable to output a notification includes at least one of the compatibility check unit being operable to play sound; the compatibility check unit being operable to play a voice message; the compatibility check unit being operable to display a message; and the compatibility check unit being operable to output a visual signal.

17. The in-vehicle device of claim 13, wherein the compatibility check unit is operable to detect, if it is determined that the first connectivity port does not meet the connection requirement, whether one or more ports of the plurality of in-vehicle connectivity ports meet the connection requirement; wherein the compatibility check unit being operable to output a notification includes the compatibility check unit being operable to output, if one or more ports have been detected, a notification that identifies the one or more ports.

18. An in-vehicle device comprising:
a plurality of connectivity ports; and
a compatibility check unit connected to the plurality of the connectivity ports,
wherein the compatibility check unit is operable to:
determine, upon receipt of identification information for a mobile device via a first connectivity port being a first port of the plurality of connectivity ports, whether the first in-vehicle connectivity port meets a connection requirement for the mobile device based on the identification information; and
output, if it is determined that the first connectivity port does not meet the connectivity connection requirement, a notification that the mobile device has been connected to a non-compliant connectivity port;
wherein the compatibility check unit is operable to detect, if it is determined that the first connectivity port does not meet the connection requirement, whether one or more ports of the plurality of in-vehicle connectivity ports meet the connection requirement; wherein the compatibility check unit being operable to output a notification includes the compatibility check unit being operable to output, if one or more ports have been detected, a notification that identifies the one or more ports.

19. The in-vehicle device of claim 18, wherein the connectivity is a USB, FireWire, or audio Jack connectivity.

20. The in-vehicle device of claim 18, wherein the connection requirement includes at least one of a power supply characteristic, a connection capability and a throughput.

21. The in-vehicle device of claim 18, wherein the compatibility check unit being operable to output a notification includes at least one of the compatibility check unit being operable to play sound; the compatibility check unit being operable to play a voice message; the compatibility check unit being operable to display a message; and the compatibility check unit being operable to output a visual signal.

22. The in-vehicle device of claim 18, wherein the compatibility check unit being operable to output a notification includes the compatibility check unit being operable to output a notification which identifies at least a second of the plurality of in-vehicle connectivity ports.
